(19) United States
(12) Patent Application Publication
(10) Pub. No.: US 2015/0277259 A1
(43) Pub. Date: Oct. 1, 2015

(54) METHOD FOR DETERMINING ELECTRO-PHOTOGRAPHIC PROCESS CONTROL SET POINTS

(71) Applicant: David Francis Cahill, Rochester, NY (US)

(72) Inventor: David Francis Cahill, Rochester, NY (US)

(21) Appl. No.: 14/226,053

(22) Filed: Mar. 26, 2014

(51) Int. Cl. G03G 15/01

(52) U.S. Cl. CPC G03G 15/01

(57) ABSTRACT

A method for determining process control set points for printing an image with clear and color toners, the method includes determining a first set of clear toner process control set points for printing a target height of clear toner on a receiver; determining a second set of color toners process control set points for printing color toner with clear toner lay-down determined by the first set of process control parameters which achieves a target color profile; estimating a new set of values for the first set of clear toner process control set points which provides a uniform topography; modifying the first clear toner and second color toners set of process control set points for printing color toners with the clear toner lay-down, using the estimated new set of first process control set points and the determined second set of color toners process control set points as starting points, for providing the target color profile and the uniform topography.

### FIELD OF THE INVENTION

The present invention relates to a method for implementing set points for electro-photographic printers and, more particularly, to implementing set which result in both color densities and a clear overlaid layer within their desired target ranges.

### BACKGROUND OF THE INVENTION

In electro-photographic printing systems, a substrate is passed through a series on printing modules where color toner is applied. In some cases, clear toner is also applied overlaying the color toner. The clear and color toner are then fused to the substrate by a combination of heat and pressure.

U.S. Pat. No. 7,139,521 discloses a method for controlling gloss and/or differential gloss of a printed image by applying a color toner lay-down onto a media substrate to form a pre-fused image; applying a transparent toner over at least a portion of the pre-fused image as a negative mask to form a coated pre-fused image; selecting parameters for the negative mask to obtain a desired level of at least one of gloss, differential gloss and image relief; fusing the coated pre-fused image to form a fused print; and finishing the fused print to increase a gloss value of the fused print.

While U.S. Pat. No. 7,139,521 addresses image relief, it indicates that the desired negative mask calculation reduces but does not eliminate color impact or variation nor does it eliminate topography variations in the image.

Although satisfactory, this method does not disclose how to control the height of the toner (step height) or how to control the topography of the clear toner for achieving a combination of a desired step height with a desired color density and a uniform topography of transparent toner.

Consequently, a need exists for overcoming the above shortcomings. The present invention overcomes these shortcomings.

### SUMMARY OF THE INVENTION

The present invention is directed to overcoming one or more of the problems set forth above. Briefly summarized, according to one aspect of the invention, the invention resides in a method for determining process control set points for printing an image with clear and color toners, the method includes determining a first set of clear toner process control set points for printing a target height of clear toner on a receiver; determining a second set of color toners process control set points for printing color toner with clear toner lay-down determined by the first set of process control parameters which achieves a target color profile; estimating a new set of values for the first set of clear toner process control set points which provides a uniform topography; modifying the first clear toner and second color toners set of process control set points for printing color toners with the clear toner lay-down, using the estimated new set of first process control set points and the determined second set of color toners process control set points as starting points, for providing the target color profile and the uniform topography.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a schematic diagram of an electro-photographic printing system useful in implementing the present invention;

FIG. 2 is a flowchart illustrating a routine for implementing the present invention;

FIG. 3A illustrates a side view in cross section of the receiver having different stacks of color toners deposited on a receiver;

FIG. 3B illustrates a side view in cross section of the receiver having different unfused stacks of color toners and the unfused clear toner overlaid on the unfused color toners; and

FIG. 3C illustrates a side view in cross section of the receiver having different fused stacks of color toners and the fused clear toner overlaid on the fused color toners

### DETAILED DESCRIPTION OF THE INVENTION

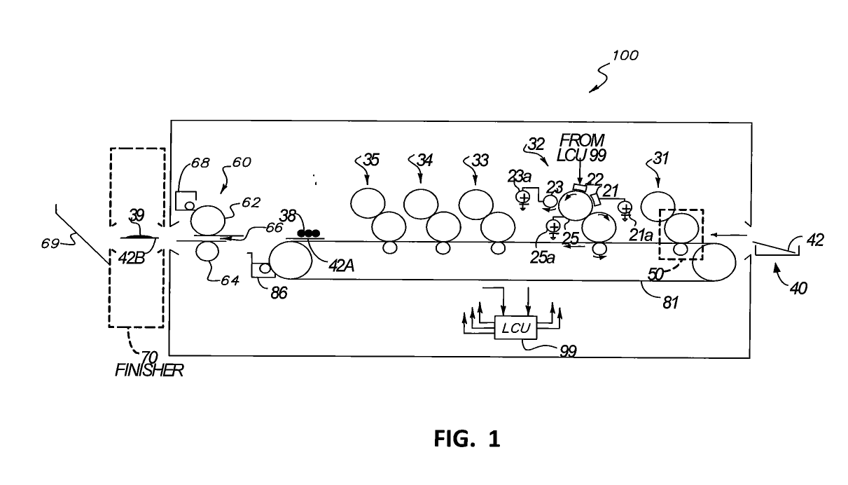

The illustrated embodiment of the present invention in FIG. 1 is shown in which each print module transfers toner to the receiver. However, other embodiments can be used such using a compliant intermediate transfer web, as is well known in the art.

FIG. 1 illustrates portions of a typical electro-photographic printer 100. The electro-photographic printer 100 is adapted to produce print images using four colors, CMYK, and clear on a receiver 42. Images can include text, graphics, photos, and other types of visual content. An embodiment involves printing using an electro-photographic print engine having four sets of single-color image-producing or printing stations or modules arranged in tandem, and all or fewer than all four colors are combined to form a print image on the receiver 42. Other electro-photographic writers or printer apparatus can also be included. Various components of electro-photographic printer 100 are shown as rollers; other configurations are also possible, including belts.

The electro-photographic printer 100 is an electro-photographic printing apparatus having a number of tandemly arranged electro-photographic image-forming printing modules 31, 32, 33, 34, and 35 also known as electro-photographic imaging subsystems. The printing modules 31, 32, 33, 34 each produce a single-color toner image for transfer using a respective transfer subsystem 50 (for clarity, only one is labeled) to the receiver 42 successively moved through the printing modules 31, 32, 33, 34 and 35. The printing module 35, also having a transfer substation 50, produces clear toner which will overlay the color toners so that the final image on the receiver 42 is devoid of undesirable recesses and have a smooth texture. The receiver 42 is transported from a supply unit 40, which can include active feeding subsystems as known in the art, into electro-photographic printer 100. In various embodiments, the visible image can be transferred directly from an imaging roller to the receiver 42, or from an imaging roller to one or more transfer roller(s) or belt(s) in sequence in transfer subsystem 50, and then to receiver 42. The receiver 42 is, for example, a selected section of a web of, or a cut sheet of, planar media such as paper, transparency film, plastic or the like. The receiver 42 can be in sheet or roll form. The receiver 42 is also referred to as a substrate.

Each printing module 31, 32, 33, 34, and 35 includes various components. For clarity, these are only shown in printing module 32. Around photoreceptor 25 are arranged, ordered by the direction of rotation of photoreceptor 25, a charger 21, an exposure subsystem 22, and a toning station 23.

In the electro-photographic process, an electrostatic latent image is formed on the photoreceptor 25 by uniformly charging photoreceptor 25 and then discharging selected areas of the uniform charge to yield an electrostatic charge pattern corresponding to the desired image (a “latent image”). The charger 21 produces a uniform electrostatic charge Vₒ on the photoreceptor 25 or its surface. The exposure subsystem 22, also referred to as a writer, selectively image-wise discharges the photoreceptor 25 to produce a latent image. The exposure setting from a logic control unit (LCU) 99 are passed to the exposure subsystem 22 for indicating the selective image-wise discharge. The exposure subsystem 22 can include a laser and raster optical scanner (ROS), one or more LEDs, or a linear LED array.

After the latent image is formed, charged toner particles are brought into the vicinity of the photoreceptor 25 by toning station 23 and are attracted to the latent image to develop the latent image into a visible image. Note that the visible image might not be visible to the naked eye depending on the composition of the toner particles (e.g. clear toner). The toning station 23 is also referred to as a development station. The toner can be applied to either the charged or discharged parts of the latent image.

After the latent image is developed into a visible image on the photoreceptor 25, the receiver 42 is brought into juxtaposition with the visible image. In the transfer subsystem 50, a suitable electric field is applied to transfer the toner particles of the visible image to the receiver 42 to form on the receiver 42 the desired print image, which is composed of a marking material 38, as shown on a receiver 42A. The imaging process is typically repeated many times with the reusable photoreceptors 25. As described in detail below, clear toner is deposited by the printing module 35 to overlay the color toners so that a smooth texture (a uniform topography) is produced. Also as described below, the color toners have their settings set in cooperation with the clear toner settings so that a target color is produced in the final image. The coordination of the clear toner and target color adjustments provides a smooth texture while maintaining the desired color.

The receiver 42A is then removed from its operative association with photoreceptor 25 and subjected to heat or pressure to permanently fix (“fuse”) marking material 38 of the print image to receiver 42A. Plural print images, e.g. of separations of different colors, are overlaid on one receiver before fusing to form a multi-color print image on receiver 42A.

Each receiver 42, during a single pass through the five printing modules 31, 32, 33, 34, and 35 can have transferred in registration thereto up to four single-color toner images to form a multi-color image. As used herein, the term “multi-color image” implies that in a print image, combinations of various of the four colors are combined to form other colors on receiver 42 at various locations on receiver 42. That is, each of the four colors of toner can be combined with toner of one or more of the other colors at a particular location on receiver 42 to form a color different than the colors of the toners combined at that location. In an embodiment, printing module 31 forms black (K) print images, printing module 32 forms yellow (Y) print images, printing module 33 forms magenta (M) print images, printing module 34 forms cyan (C) print images, and printing module 35 forms a clear overcoat.

The receiver 42A is shown after passing through printing module 35. In these embodiments, marking material 38 on receiver 42A includes unfused toner particles.

Subsequent to transfer of the respective print images, overlaid in registration, one from each of the respective printing modules 31, 32, 33, 34, and 35, the receiver 42A is advanced to a fixing station 60, i.e. a fusing or fixing assembly, to fuse the marking material 38 to the receiver 42A. A transport web 81 transports the print-image-carrying receivers (e.g., 42A) to the fixing station 60, which fixes the toner particles to the respective receivers 42A by the application of heat and pressure. The receivers 42A are serially de-tacked from transport web 81 to permit them to feed cleanly into fixing station 60. Transport web 81 is then reconditioned for reuse at cleaning station 86 by cleaning and neutralizing the charges on the opposed surfaces of the transport web 81. A mechanical cleaning station (not shown) for scraping or vacuuming toner off transport web 81 can also be used independently or with cleaning station 86. The mechanical cleaning station can be disposed along transport web 81 before or after cleaning station 86 in the direction of rotation of transport web 81.

The fixing station 60 includes a heated fixing member 62 and an opposing pressure member 64 that form a fixing nip 66 therebetween. In an embodiment, the fixing station 60 also includes a release fluid application substation 68 that applies release fluid, e.g. silicone oil, to fixing member 62. Alternatively, wax-containing toner is used without applying release fluid to fixing member 62. Other embodiments of fusers, both contact and non-contact, can be employed. For example, solvent fixing uses solvents to soften the toner particles so they bond with the receiver 42. Photoflash fusing uses short bursts of high-frequency electromagnetic radiation (e.g. ultraviolet light) to melt the toner. Radiant fixing uses lower-frequency electromagnetic radiation (e.g. infrared light) to more slowly melt the toner. Microwave fixing uses electromagnetic radiation in the microwave range to heat the receivers (primarily), thereby causing the toner particles to melt by heat conduction, so that the toner is fixed to the receiver 42.

The receivers (e.g., receiver 42B) carrying the fused image (e.g., fused image 39) are transported in a series from the fixing station 60 along a path either to a remote output tray 69, or back to the printing modules 31, 32, 33, 34, and 35 to create an image on the backside of the receiver (e.g., receiver 42B), i.e. to form a duplex print. The electro-photographic printer 100 can also include multiple fixing stations 60 to support applications such as overprinting, as well known in the art.

In various embodiments, between the fixing station 60 and the output tray 69, a receiver 42B passes through a finisher 70. The finisher 70 performs various media-handling operations, such as folding, stapling, saddle-stitching, collating, and binding.

The electro-photographic printer 100 includes main printer apparatus LCU 99, which receives input signals from the various sensors associated with electro-photographic printer 100 and sends control signals, such as settings for the clear and color toners, to the corresponding components of the electro-photographic printer 100. The LCU 99 can include a microprocessor incorporating suitable look-up tables and control software executable by the LCU 99. It can also include a field-programmable gate array (FPGA), a programmable logic device (PLD), microcontroller, or other digital control system. The LCU 99 can include memory for storing control software and data. The sensors associated with the fusing assembly provide appropriate signals to the LCU 99. In response to the sensors, the LCU 99 issues command and control signals that adjust the heat or pressure within the fixing nip 66 and other operating parameters of the fixing station 60 for receivers. This permits the electro-photographic printer 100 to print on the receivers of various thicknesses and surface finishes, such as glossy or matte.

Image data for writing by the electro-photographic printer 100 can be processed by a raster image processor (RIP; not shown), which can include a color separation screen generator or generators. The output of the RIP can be stored in frame or line buffers for transmission of the color separation print data to each of respective LED writers, e.g. for black (K), yellow (Y), magenta (M), and cyan (C) respectively. The RIP or color separation screen generator can be a part of the electro-photographic printer 100 or remote therefrom. The image data processed by the RIP can be obtained from a color document scanner or a digital camera or produced by a computer or from a memory or network which typically includes image data representing a continuous image that needs to be reprocessed into halftone image data in order to be adequately represented by the printer. The RIP can perform image processing processes, e.g. color correction, in order to obtain the desired color print. The color image data is separated into the respective colors and converted by the RIP to halftone dot image data in the respective color using matrices, which comprise desired screen angles (measured counterclockwise from rightward, the +X direction) and screen rulings. The RIP can be a suitably-programmed computer or logic device and is adapted to employ stored or computed matrices and templates for processing separated color image data into rendered image data in the form of halftone information suitable for printing. These matrices can include a screen pattern memory (SPM).

Various parameters of the components of a printing module (e.g., printing module 31) can be selected to control the operation of electro-photographic printer 100. In an embodiment, charger 21 is a corona charger including a grid between the corona wires (not shown) and photoreceptor 25. A voltage source 21a applies a voltage to the grid to control charging Vₒ of the photoreceptor 25. In an embodiment, a voltage bias is applied to the toning station 23 by a voltage source 23a to control the electric field, and thus the rate of toner transfer, from the toning station 23 to the photoreceptor 25. In an embodiment, a voltage is applied to a conductive base layer of the photoreceptor 25 by a voltage source 25a before development, that is, before the toner is applied to the photoreceptor 25 by the toning station 23. The applied voltage can be zero; the base layer can be grounded. This also provides control over the rate of toner deposition during development. In an embodiment, the exposure applied by the exposure subsystem 22 to the photoreceptor 25 is controlled by the LCU 99 to produce a latent image corresponding to the desired print image.

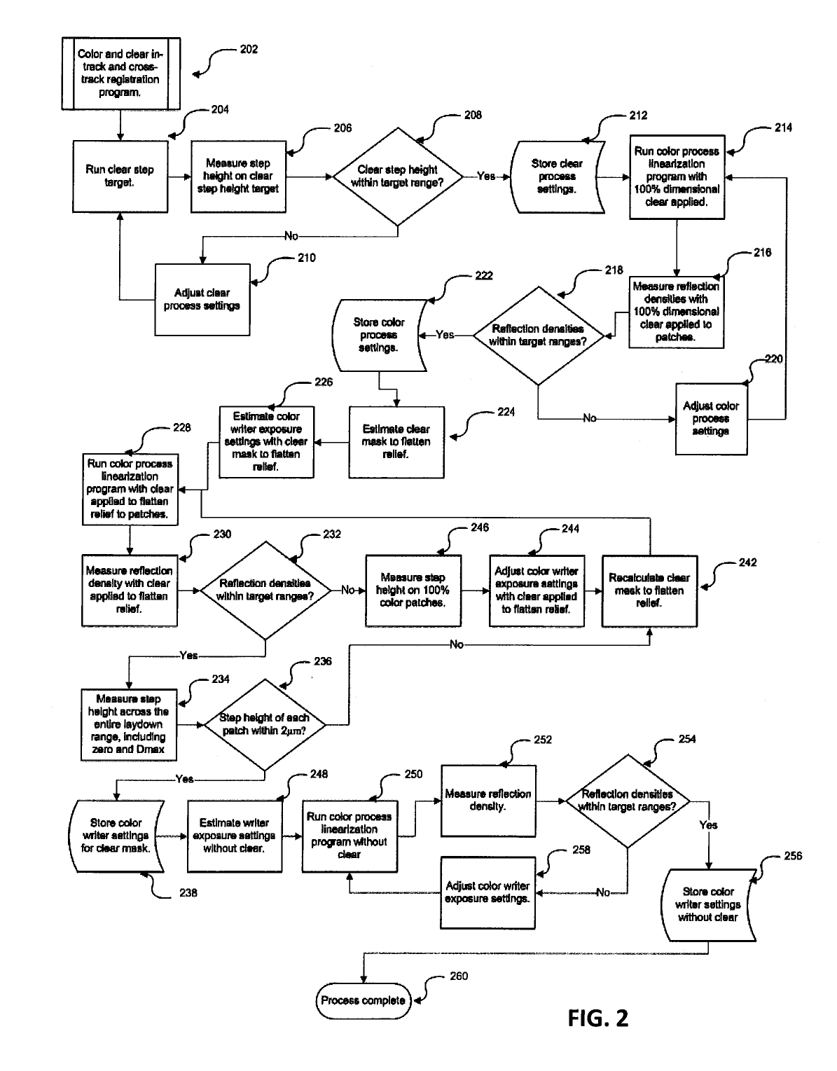

Referring to FIG. 2, there is shown a flowchart for determining process control set points for printing an image with the clear and color toners. The flowchart represents a software routine or hardware routine or a combination of a software/hardware routine and uses the word “subroutine” to indicate portions of the routine; the subroutine can be one line of code or many lines of code or whether one simple piece of hardware or many pieces of hardware or a combination of hardware and software. These are preferable subroutines and other similar subroutines can be used to accomplish the same object and are within the scope of the present invention.

It is a prerequisite for the entire process that there be good in-track and cross-track registration for the clear and color toner as shown in 202. In regards to the substantive content, subroutine 204 through 212 determine a first set of clear toner process control set points for printing a target height of clear toner on a substrate (i.e., the receiver 42). Subroutine 204 deposits clear toner on a target substrate, and subroutine 206 measures the height of the clear toner. This measured height is then analyzed to determine if this height is within a target range, typically greater than the height of the four color lay-down increased by at least fifty percent. If the height is within target range, the clear process control settings are stored 212. If the height is not within target range, the clear process control settings are adjusted 210 by repeating subroutines 204 through 208 as many times as necessary until the clear toner process settings are within the target range, which are then stored 212.

Subroutine 214 through 222 determines a second set of color toners process control set points for printing color toner with overlaying clear toner lay-down determined by the first set of process control parameters (subroutine 204 through 212) for achieving a target color profile. In this regard, subroutine 214 runs a color process linearization program with preferably 100% dimensional clear applied on color patches, and subroutine 216 measures the reflection densities with 100% dimensional clear applied to the color patches. Dimensional clear refers to clear toner with an average diameter of 50 microns rather than the usual diameter range of 6-12 microns, which is a preferred embodiment for making high stacks (thus dimensional) of toner material. If the reflection densities are within range 218, the color toner process control set points are stored 222. If the reflection densities are not within target range 218, the color process control settings are adjusted in subroutine 220 by repeating subroutine 214 through 220 as many times as necessary until the color toner process settings are within the target range.

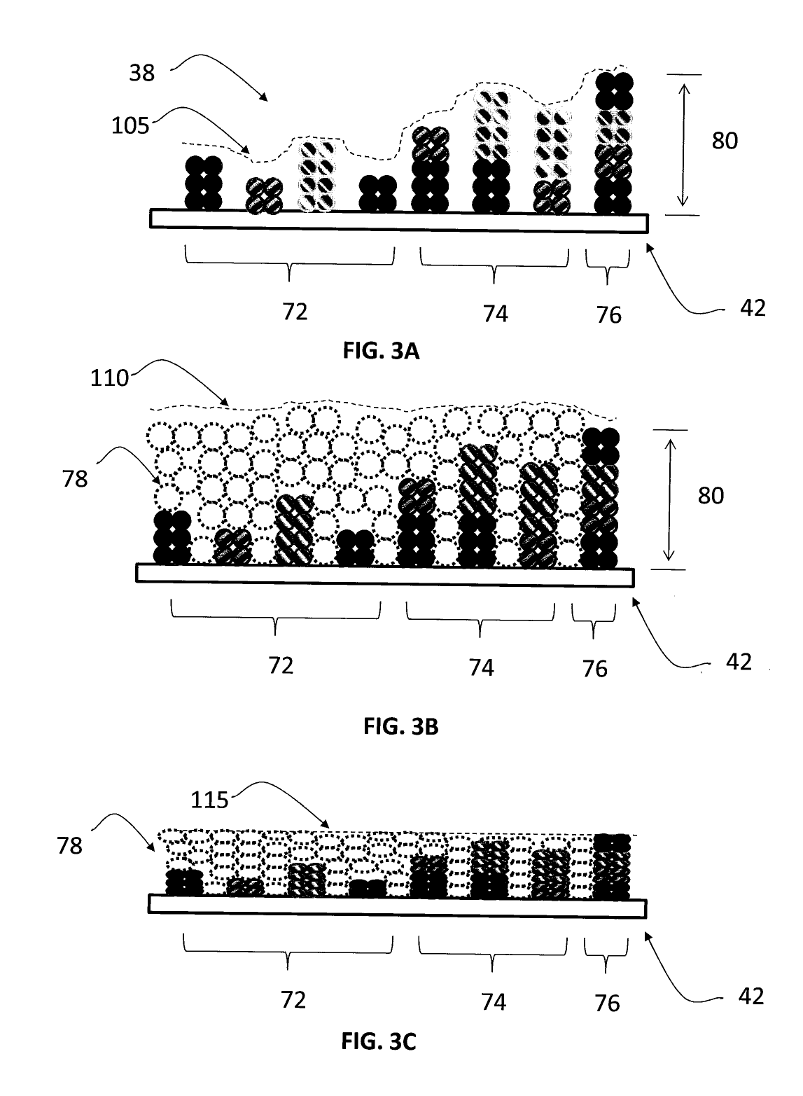

Subroutine 224 estimates a new set of values for the first set of clear toner process control set points for providing a uniform topography 115, i.e., a smooth texture (see FIG. 3). In other words, new clear toner process control settings are estimated so that, when the clear toner is applied over each of the determined color densities, a uniform topography is maintained. It is understood by those skilled in the art that uniform topography means having a smooth topography imperceptible to the human eye and touch.

Subroutine 228 through 246 modifies the first clear toner process control set points (subroutines 204 through subroutine 212) and the second color toners set of process control set points (subroutine 214 through subroutine 222) for printing color toners with the clear toner lay-down, using the estimated new set of first process control set points (subroutine 224) and the determined second set of color toners process control set points (subroutine 214 through subroutine 220) as starting points, for providing both the target color profile and the uniform topography in combination. Subroutine 226 estimates color writer exposure setting for exposure subsystem 22 (FIG. 1) with clear mask applied to flatten relief areas (areas that are not within the desired topography). Subroutine 228 runs color process linearization program with clear applied to flatten relief patches. Color process linearization means to determine writer setting to produce desired color across the entire color gamut with the clear mask applied to give uniform topography. Subroutine 230 measures the reflection densities with clear applied to flatten the relief. Subroutine 232 determines whether the reflection densities are within range. If not, subroutine 246 measures the step height on 100% color patches without clear. Subroutine 242 adjusts the color writer exposure settings via exposure subsystem 22 (FIG. 1) with clear applied to flatten the relief. Subroutine 242 recalculates a clear mask overlay to flatten the relief. Subroutines 228 through 242 are repeated until the reflection densities are within range. When the reflection densities are within range, subroutine 234 measures the stack height across the entire lay-down range including 100% (monochrome Dmax), 320% (CMYK process black Dmax) and blank patches (no color applied to substrate). Subroutine 236 measures the step height of each patch to determine whether they are within 2 μm. This is to ensure a uniform or substantially uniform topography.

If not, subroutines 228 through 242 and subroutine 232 through 236 are repeated until the subroutine height is within 2 μm. When the subroutine height is within 2 μm, the color writer settings for the clear mask are stored (via exposure subsystem 22 see FIG. 1).

Optional subroutines 248 through 258 determine a third set of color toners process control set points for printing color toner with no clear toner lay-down. Subroutine 248 estimates the writer exposure settings without a clear mask. Subroutine 250 runs the color process linearization program without clear. Subroutine 252 measures the reflection density, and subroutine 252 measures the reflection density. Subroutine 254 determines if the reflection densities are within target range. If not, subroutine 258 adjusts the color writer exposure settings and subroutines 250 through 254 are repeated until the reflection densities are within target range. Once they are within range, subroutine 256 stores the color settings without clear and the subroutine is complete (subroutine 260).

FIG. 3A illustrates a side view in cross section of the receiver 42 having different stacks of marking materials 38 deposited on the receiver 42. There are shown lay-downs of mono-chrome 72, bi-chrome 74, and process black 76 (4 colors—CMYK) “max laydown” 80. It is readily seen that the color toner forms a very non-uniform topography 105.

FIG. 3B illustrates a side view in cross section of the receiver 42 having different stacks of color toners and the clear toner overlaid on the color toners. There are shown mono-chrome 72, bi-chrome 74, and process black 76 (4 colors—CMYK) “max laydown” 80 color toner. On top of the color toner is shown the clear toner 78. It is readily seen that the unfused toner stacks form a substantially uniform topography 110.

FIG. 3C illustrates a side view in cross section of the image in FIG. 3B after fusing with the receiver 42 having different stacks of color toners and the clear toner overlaid on the color toners. There are shown mono-chrome 72, bi-chrome 74, and process black 76 (4 colors—CMYK) “max laydown” 80 color toner. On top of the color toner is shown the clear toner 78. It is readily seen that the clear toner forms a uniform topography 115. The color toners are within a desired reflection density even with the clear toner overlaid thereon. The target height of the clear toner is greater than a maximum height of a four color toner lay-down as in subroutine 246-242.

The present invention has been described in detail with particular reference to certain preferred embodiments thereof, but it will be understood that variations and modifications can be effected within the spirit and scope of the invention.

### PARTS LIST

21 charger
21a voltage source
22 exposure subsystem
23 toning station
23a voltage source
25 photoreceptor
25a voltage source
31, 32, 33, 34, 35 printing module
38 marking material
39 fused image
40 supply unit
42, 42A, 42B receiver
50 transfer subsystem
60 fixing station
62 fixing member
64 pressure member
66 fixing nip
68 release fluid application substation
69 output tray
70 finisher
72 monochrome
74 bi-chrome
76 process black
78 clear toner
80 max-uniform
81 transport web
86 cleaning station
99 logic and control unit (LCU)
100 electro-photographic printer
105 non-uniform topography
110 substantially uniform topography
115 uniform topography
202 color and clear intrack and cross-track registration program
204-212 subroutine to determine a first set of clear toner process control set points
214-222 subroutine to determine a second set of color toners process control set points
224 subroutine to estimate a new set of values for the first set of color toner process control set points
226 subroutine to estimate color writer exposure setting for exposure subsystem
228-246 subroutines to modify the first clear toner process control set points
248-258 optional to subroutine determine a third set of color toners process control set points
260 subroutine is complete

1. A method for determining process control set points for printing an image with clear and color toners, the method comprising:
(a) determining a first set of clear toner process control set points for printing a target height of clear toner on a receiver;
(a1) depositing clear toner on a target substrate, and measuring the height of the clear toner over a range of clear toner laydowns;
(b) determining a second set of color toners process control set points for printing color toner with clear toner lay-down determined by the first set of clear toner process control set points which achieves a target color profile;
(b1) measuring the step height on the color patch corresponding to 100% laydown;
(c) estimating a new set of values for the first set of clear toner process control set points which provides a uniform topography;
(d) modifying the first set of clear toner and second set of color toners process control set points for printing color toners with the clear toner lay-down, using the estimated new set of first clear toner process control set points and the determined second set of color toners process control set points as starting points, for providing the target color profile and the uniform topography.

2. The method as in claim 1, wherein the target height is greater than a maximum height of a four color toner lay-down that can be achieved in a toner printing process.

3. The method as in claim 2, wherein only a Vₒ (photoreceptor voltage) set point of the first set of clear toner process control set points is adjusted.

4. The method as in claim 1, wherein only an exposure profile of the second set of color toners process control set points is adjusted.

5. The method as in claim 1, wherein modifying the first clear toner and second color toners set of process control set points includes one or more iterations until the color profile and the topography convergence to the target profile and the uniform topography within tolerance ranges.

6. The method as in claim 5 comprising:
measuring the topography of the clear toner in combination with the color toner across the image;
wherein the tolerance range for the uniform topography is 2 μm.

7. The method as claim 1 further including the subroutine of determining a third set of color toners process control set points for printing color toner with no clear toner lay-down.
